(19) United States
(12) Patent Application Publication
(10) Pub. No.: US 2026/0188294 A1
(43) Pub. Date: Jul. 2, 2026

(54) AUDIO PROCESSING CIRCUIT USING LEAKAGE DETECTION TO CONTROL ONE OR MORE ADAPTIVE FILTERS AND ASSOCIATED METHOD

(71) Applicant: Airoha Technology Corp., Hsinchu County (TW)

(72) Inventors: Li-Wen Chi, Hsinchu County (TW); Chih-Chi Weng, Hsinchu County (TW)

(73) Assignee: Airoha Technology Corp., Hsinchu County (TW)

(21) Appl. No.: 19/291,616

(22) Filed: Aug. 6, 2025

Related U.S. Application Data
(60) Provisional application No. 63/739,130, filed on Dec. 27, 2024.

(51) Int. Cl. G10K 11/178

(52) U.S. Cl. CPC G10K 11/17825; G10K 11/17823; G10K 11/17827; G10K 11/17881; G10K 11/17885; G10K 2210/3012; G10K 2210/3026; G10K 2210/3027; G10K 2210/3028; G10K 2210/3056

(57) ABSTRACT

An audio processing circuit is used for generating an output signal for an audio function, and includes at least one adaptive filter and a leakage detection circuit. The at least one adaptive filter controls the output signal. The leakage detection circuit performs leakage detection according to a first input signal and a second input signal, and adjusts the at least one adaptive filter according to a leakage detection result. The first input signal is indicative of noise signal signature. The second input signal is derived from an error signal output by an error microphone that picks up remnant noise resulting from the audio function.

### CROSS REFERENCE TO RELATED APPLICATIONS

This application claims the benefit of U.S. Provisional Application No. 63/739,130, filed on Dec. 27, 2024. The content of the application is incorporated herein by reference.

### BACKGROUND OF THE INVENTION

### 1. Field of the Invention

The present invention relates to an audio function (e.g., a noise reduction/cancellation mode or a pass-through mode), and more particularly, to an audio processing circuit using leakage detection to control one or more adaptive filters and an associated method.

### 2. Description of the Prior Art

Active noise control (ANC) can cancel the unwanted noise based on the principle of superposition. Specifically, an anti-noise signal of equal amplitude and opposite phase is generated and combined with the unwanted noise signal, thus resulting in cancellation of both noise signals at a local quite zone (e.g. user's ear drum). Compared to a static ANC technique using filter coefficients that are tuned and fixed in a factory, an adaptive ANC technique is capable of finding better filter coefficients for users with different wearing styles. However, the stability of the adaptive ANC technique is worse than that of the static ANC technique, and the control difficulty and complexity of the adaptive ANC technique is higher than that of the static ANC technique. For example, the adaptive ANC technique may adopt a least mean square (LMS) based algorithm to adjust ANC filter coefficients. However, the LMS-based algorithm incurs computational complexity mainly due to lots of vector multiplications. Thus, there is a need for an innovative low-complexity control scheme of adaptive ANC filters.

### SUMMARY OF THE INVENTION

One of the objectives of the claimed invention is to provide an audio processing circuit using leakage detection to control one or more adaptive filters and an associated method.

According to a first aspect of the present invention, an exemplary audio processing circuit for generating an output signal for an audio function is disclosed. The exemplary audio processing circuit includes at least one adaptive filter and a leakage detection circuit. The at least one adaptive filter is arranged to control the output signal. The leakage detection circuit is arranged to perform leakage detection according to a first input signal and a second input signal, and adjust the at least one adaptive filter according to a leakage detection result, wherein the first input signal is indicative of noise signal signature, and the second input signal is derived from an error signal output by an error microphone that picks up remnant noise resulting from the audio function.

According to a second aspect of the present invention, an exemplary audio processing method for generating an output signal for an audio function is disclosed. The exemplary audio processing method includes: controlling, by at least one adaptive filter, the output signal; performing leakage detection according to a first input signal and a second input signal, wherein the first input signal is indicative of noise signal signature, and the second input signal is derived from an error signal output by an error microphone that picks up remnant noise resulting from the audio function; and adjusting the at least one adaptive filter according to a leakage detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an audio processing system according to an embodiment of the present invention.

FIG. 2 is a diagram illustrating a first adaptive ANC system with leakage detection according to an embodiment of the present invention.

FIG. 3 is a diagram illustrating a second adaptive ANC system with leakage detection according to an embodiment of the present invention.

FIG. 4 is a diagram illustrating a third adaptive ANC system with leakage detection according to an embodiment of the present invention.

FIG. 5 is a diagram illustrating a fourth adaptive ANC system with leakage detection according to an embodiment of the present invention.

FIG. 6 is a diagram illustrating a fifth adaptive ANC system with leakage detection according to an embodiment of the present invention.

FIG. 7 is a diagram illustrating a sixth adaptive ANC system with leakage detection according to an embodiment of the present invention.

FIG. 8 is a diagram illustrating a seventh adaptive ANC system with leakage detection according to an embodiment of the present invention.

FIG. 9 is a diagram illustrating an eighth adaptive ANC system with leakage detection according to an embodiment of the present invention.

FIG. 10 is a diagram illustrating a ninth adaptive ANC system with leakage detection according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

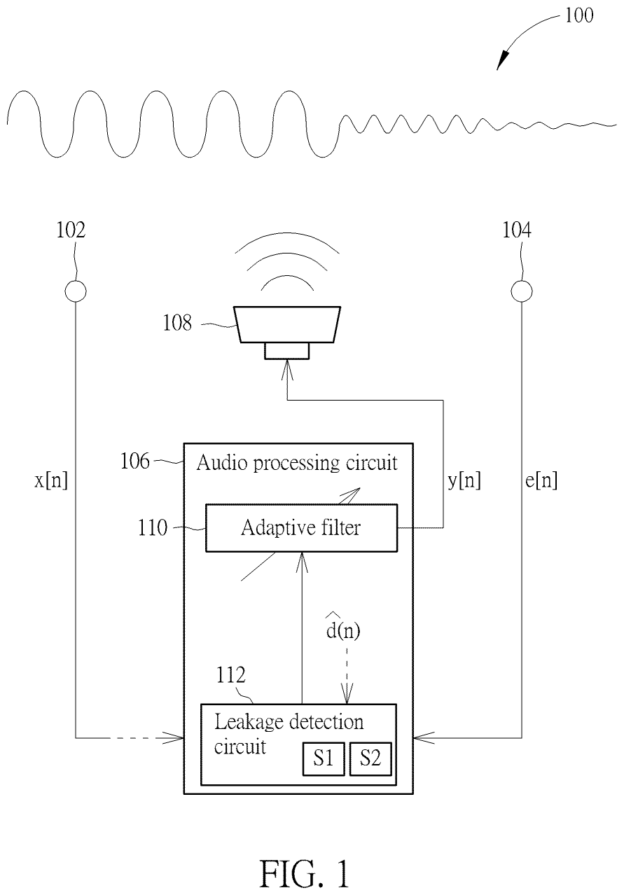

FIG. 1 is a diagram illustrating an audio processing system according to an embodiment of the present invention. The audio processing system 100 may be installed on an earphone device such as an earbud. In this embodiment, the audio processing system 100 includes a reference microphone 102, an error microphone 104, an audio processing circuit 106, and a loudspeaker 108. In this embodiment, the audio processing circuit 106 includes at least one adaptive filter 110 and a leakage detection circuit 112. Each adaptive filter 110 may be a main filter of the audio processing system 100 for achieving a main audio function of the audio processing system 100. For example, each adaptive filter 110 may be an adaptive active noise control (ANC) filter. For another example, each adaptive filter 110 may be a pass-through (PT) filter.

For better comprehension of technical features of the present invention, the following assumes that the audio processing system 100 is an adaptive ANC system, the audio processing circuit 106 is an ANC circuit, and each adaptive filter 110 is an adaptive ANC filter. Hence, in the following, the terms “audio processing circuit” and “ANC circuit” may be interchangeable, and the terms “adaptive filter” and “adaptive ANC filter” may be interchangeable.

The ANC circuit 106 is arranged to generate an output signal (e.g., anti-noise signal) y[n] for an audio function (e.g., noise reduction/cancellation). Specifically, the anti-noise signal y[n] may be a digital signal that is transmitted to the loudspeaker 108 for playback of analog anti-noise, where the analog anti-noise is intended to reduce/cancel the unwanted ambient noise through superposition. The ANC circuit 106 includes at least one adaptive filter 110 each arranged to estimate the unknown transfer function of a primary path from the reference microphone 102 to a position where the noise reduction/cancellation is to be realized, and is called ANC filter. In this embodiment, each adaptive filter 110 can be adaptively adjusted by the leakage detection circuit 112. It should be noted that the number of adaptive filters 110 used by the ANC circuit 106 may depend on the adaptive ANC structure employed by the ANC circuit 106. For example, the ANC circuit 106 may employ an adaptive feedforward (FF) ANC structure, an adaptive feedback (FB) ANC structure, or an adaptive hybrid ANC structure which is a combination of an adaptive FF ANC structure and an adaptive FB ANC structure. In other words, the adaptive filter(s) 110 may be a part of an adaptive FF ANC structure, an adaptive FB ANC structure, or an adaptive hybrid ANC structure.

The reference microphone 102 is arranged to pick up ambient noise from an external noise source, and generate a reference signal x[n]. The error microphone 104 is arranged to pick up remnant noise resulting from the audio function (e.g., noise reduction/cancellation), and generate an error signal e[n]. One or both of the reference signal x[n] and the error signal e[n] may be used by the leakage detection circuit 112 for adaptively adjusting the adaptive filter(s) 110. In this embodiment, the leakage detection circuit 112 is arranged to perform leakage detection according to a first input signal S1 and a second input signal S2, and adjust the adaptive filter(s) 110 according to a leakage detection result, where the first input signal S1 is indicative of noise signal signature (e.g., noise signal magnitude), such as ambient noise received by the reference microphone 102, and the second input signal S2 is derived from the error signal e[n] output by the error microphone 104 that picks up remnant noise resulting from the audio function (e.g., noise reduction/cancelation), such as a noise signal derived from the ambient noise picked up by the error microphone 104. It should be noted that the first input signal S1 is not a downlink (DL) reference signal (e.g., a playback reference signal). In addition, the leakage detection function can operate at the time the ANC function is enabled. In some embodiments of the present invention, the first input signal S1 may be derived from the reference signal x[n] output by the reference microphone 102 that picks up ambient noise. In some embodiments of the present invention, the first input signal S1 may be derived from an estimated signal \hat{d}(n) of a noise signal at a position where the audio function (e.g., noise reduction/cancellation) occurs.

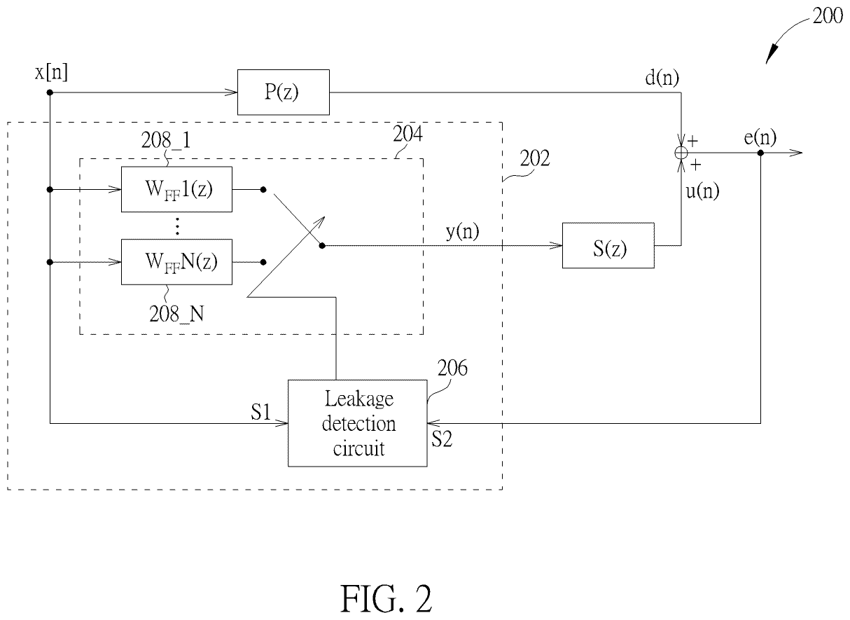

FIG. 2 is a diagram illustrating a first adaptive ANC system with leakage detection according to an embodiment of the present invention. The adaptive ANC system 200 includes an ANC circuit 202. The ANC circuit 202 includes an adaptive filter 204 and a leakage detection circuit 206. The audio processing circuit (e.g., ANC circuit) 106 shown in FIG. 1 may be realized by the ANC circuit 202. The transfer function of an acoustic channel, also called the primary path, between the reference signal x[n] (which is the ambient noise picked up by the reference microphone 102) and a noise signal d[n] at a position where noise reduction/cancellation occurs is represented by P(z). The transfer function of an electro-acoustic channel, also called the secondary path, between the anti-noise signal y[n] (which is an output of the ANC circuit 202) and the error signal e[n] (which is the remnant noise picked by the error microphone 104) is represented by S(z). Hence, regarding the acoustic superposition in the space from the ANC circuit 202 to the error microphone 104, there is a signal u[n] resulting from passing the anti-noise signal y[n] through the secondary path transfer function S(z). The error signal e[n] may be a superposition result of the signal u[n] and the noise signal d[n].

In this embodiment, the ANC circuit 202 employs an adaptive FF ANC structure having the adaptive filter 204 included therein, where an input of the adaptive filter 204 is derived from the reference signal x[n]. As shown in FIG. 2, the adaptive filter 204 is implemented by a selective FF filter having a plurality of static filters 208_1-208_N (N≥2), where the static filter 208_1 has a fixed transfer function W_{FF}1(z) defined by fixed filter coefficients, and the static filter 208_N has a fixed transfer function W_{FF}N(z) defined by fixed filter coefficients. The leakage detection circuit 206 is arranged to perform leakage detection according to a first input signal S1 and a second input signal S2, and select one of the static filters 208_1-208_N as an active filter of the adaptive filter 204 according to a leakage detection result. In this embodiment, the first input signal S1 is set by the reference signal x[n] (i.e., S1=x[n]), and the second input signal S2 is set by the error signal e[n] (i.e., S2=e[n]). Hence, the leakage detection circuit 206 may obtain the leakage detection result through calculating a ratio of the second input signal S2 to the first input signal S1

$$( i . e . , \frac{E [ z ]}{X [ z ]} )$$

as a leakage detection factor which is proportional to the leakage condition.

Signals of the adaptive ANC system 200 may be expressed using the following formulas.

$$e ( n ) = d ( n ) + x ( n ) * {W}_{FF} * S , where {W}_{FF} = {W}_{FF} 1 , … , or {W}_{FF} N \qquad ( 1 )$$

$$E ( z ) = X ( z ) P ( z ) + X ( z ) S ( z ) {W}_{FF} ( z ) \qquad ( 2 )$$

$$E ( z ) = X ( z ) * ( P ( z ) + S ( z ) {W}_{FF} ( z ) ) \qquad ( 3 )$$

$$\frac{E ( z )}{X ( z )} = P ( z ) + S ( z ) {W}_{FF} ( z ) \qquad ( 4 )$$

If S(z)W_{FF}(z) approaches to P(z), E(z) approaches to zero. The

$$\frac{E [ z ]}{X [ z ]}$$

ratio also could be taken as a leakage detection factor. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 202 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

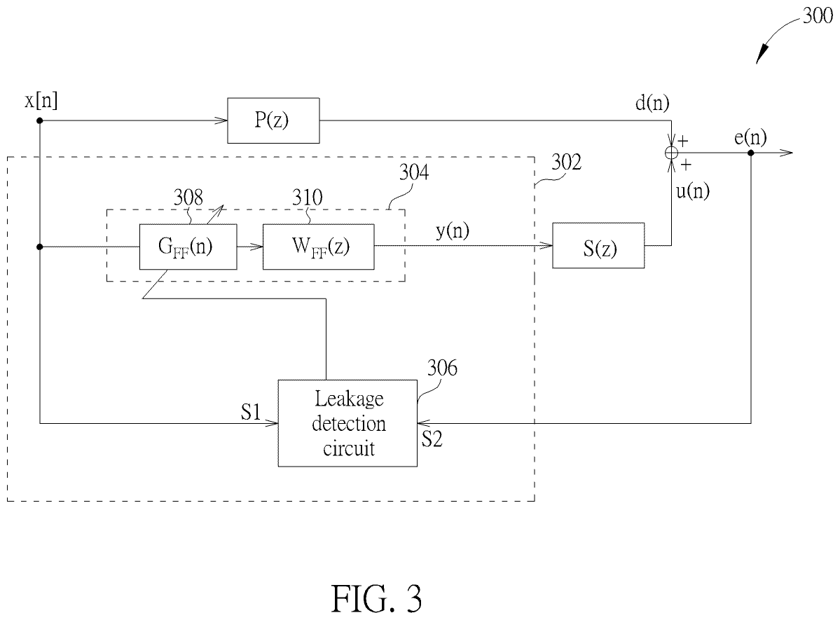

FIG. 3 is a diagram illustrating a second adaptive ANC system with leakage detection according to an embodiment of the present invention. The adaptive ANC system 300 includes an ANC circuit 302. The ANC circuit 302 includes an adaptive filter 304 and a leakage detection circuit 306. The audio processing circuit (e.g., ANC circuit) 106 shown in FIG. 1 may be realized by the ANC circuit 302. In this embodiment, the ANC circuit 302 employs an adaptive FF ANC structure having the adaptive filter 304 included therein, where an input of the adaptive filter 304 is derived from the reference signal x[n]. As shown in FIG. 3, the adaptive filter 304 is implemented by an adaptive gain amplifier 308 and a static filter 310 connected in series, where the static filter 310 has a fixed transfer function W_{FF}(z) defined by fixed filter coefficients, and the adaptive gain amplifier 308 has a controllable gain G_{FF}(n). The leakage detection circuit 306 is arranged to perform leakage detection according to a first input signal S1 and a second input signal S2, and adjust the controllable gain G_{FF}(n) of the adaptive gain amplifier 308 according to a leakage detection result. In this embodiment, the first input signal S1 is set by the reference signal x[n] (i.e., S1=x[n]), and the second input signal S2 is set by the error signal e[n] (i.e., S2=e[n]). Hence, the leakage detection circuit 306 may obtain the leakage detection result through calculating a ratio of the second input signal S2 to the first input signal S1

$$( i . e . , \frac{E [ z ]}{X [ z ]} )$$

as a leakage detection factor which is proportional to the leakage condition. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 302 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

It should be noted that the adaptive gain amplifier 308 is a linear time-invariant (LTI) system, and the adaptive gain amplifier 308 and the static filter 310 may be swapped. In other words, the adaptive gain amplifier 308 may be put before or after the static filter 310, depending upon actual design considerations.

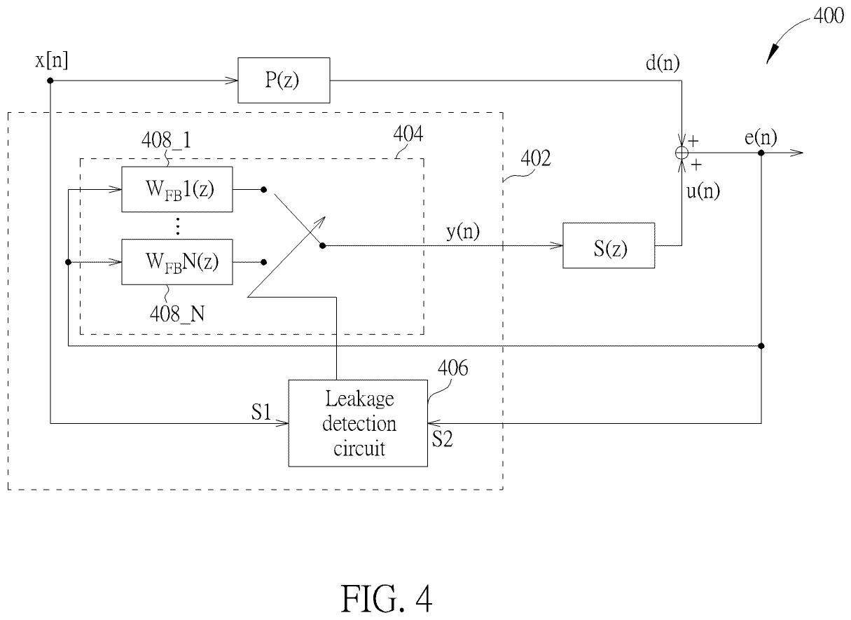

FIG. 4 is a diagram illustrating a third adaptive ANC system with leakage detection according to an embodiment of the present invention. The adaptive ANC system 400 includes an ANC circuit 402. The ANC circuit 402 includes an adaptive filter 404 and a leakage detection circuit 406. The audio processing circuit (e.g., ANC circuit) 106 shown in FIG. 1 may be realized by the ANC circuit 402. In this embodiment, the ANC circuit 402 employs an adaptive FB ANC structure having the adaptive filter 404 included therein, where an input of the adaptive filter 404 is derived from the error signal e[n]. As shown in FIG. 4, the adaptive filter 404 is implemented by a selective FB filter having a plurality of static filters 408_1-408_N (N≥2), where the static filter 408_1 has a fixed transfer function W_{FB}1(z) defined by fixed filter coefficients, and the static filter 408_N has a fixed transfer function W_{FB}N(z) defined by fixed filter coefficients. The leakage detection circuit 406 is arranged to perform leakage detection according to a first input signal S1 and a second input signal S2, and select one of the static filters 408_1-408_N as an active filter of the adaptive filter 404 according to a leakage detection result. In this embodiment, the first input signal S1 is set by the reference signal x[n] (i.e., S1=x[n]), and the second input signal S2 is set by the error signal e[n] (i.e., S2=e[n]). Hence, the leakage detection circuit 406 may obtain the leakage detection result through calculating a ratio of the second input signal S2 to the first input signal S1

$$( i . e . , \frac{E [ z ]}{X [ z ]} )$$

as a leakage detection factor which is proportional to the leakage condition. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 402 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

Furthermore, the FB ANC system must ensure stability since it is a closed-loop system. In this embodiment, the static filters 408_1-408_N of the adaptive filter 404 can be pre-verified to ensure the system stability, eliminating the need to calculate system stability at runtime. Specifically, since the proposed ANC circuit 402 uses pre-defined filters (which are static filters) rather than LMS-based filters (which are adaptive filters), there is no need to ensure the stability of the FB ANC system at runtime, which reduces the computational complexity.

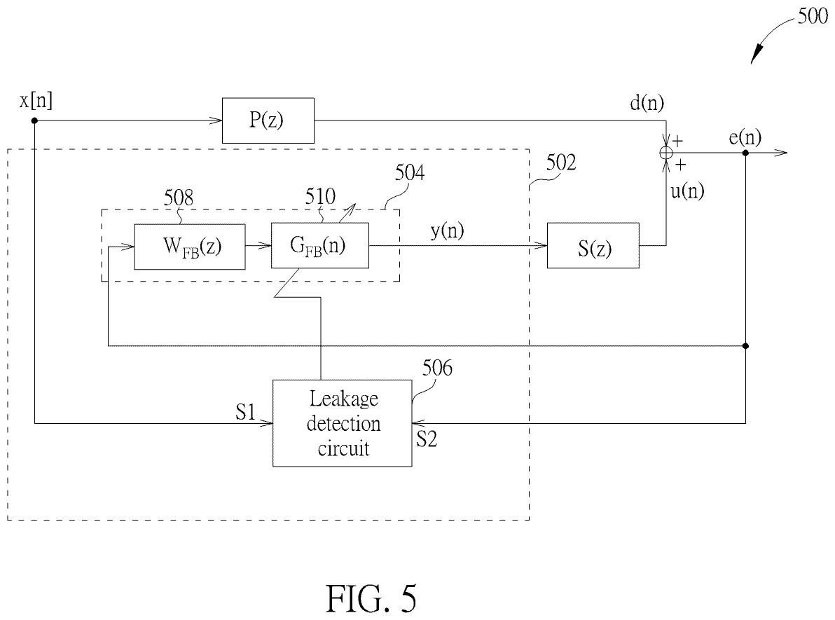

FIG. 5 is a diagram illustrating a fourth adaptive ANC system with leakage detection according to an embodiment of the present invention. The adaptive ANC system 500 includes an ANC circuit 502. The ANC circuit 502 includes an adaptive filter 504 and a leakage detection circuit 506. The audio processing circuit (e.g., ANC circuit) 106 shown in FIG. 1 may be realized by the ANC circuit 502. In this embodiment, the ANC circuit 502 employs an adaptive FB ANC structure having the adaptive filter 504 included therein, where an input of the adaptive filter 504 is the error signal e[n]. As shown in FIG. 5, the adaptive filter 504 is implemented by an adaptive gain amplifier 510 and a static filter 508 connected in series, where the static filter 508 has a fixed transfer function W_{FB}(z) defined by fixed filter coefficients, and the adaptive gain amplifier 510 has a controllable gain G_{FB}(n). The leakage detection circuit 506 is arranged to perform leakage detection according to a first input signal S1 and a second input signal S2, and adjust the controllable gain G_{FB}(n) of the adaptive gain amplifier 510 according to a leakage detection result. In this embodiment, the first input signal S1 is set by the reference signal x[n] (i.e., S1=x[n]), and the second input signal S2 is set by the error signal e[n] (i.e., S2=e[n]). Hence, the leakage detection circuit 506 may obtain the leakage detection result through calculating a ratio of the second input signal S2 to the first input signal S1

$$( i . e . , \frac{E [ z ]}{X [ z ]} )$$

as a leakage detection factor which is proportional to the leakage condition. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 502 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

It should be noted that the adaptive gain amplifier 510 is an LTI system, and the adaptive gain amplifier 510 and the static filter 508 may be swapped. In other words, the adaptive gain amplifier 510 may be put before or after the static filter 508, depending upon actual design considerations.

In some embodiments of the present invention, it is possible that the adaptive ANC system may have only a single microphone (e.g., the error microphone 104 shown in FIG. 1). Since the reference microphone 102 shown in FIG. 1 is absent, the reference signal x[n] is not available to the leakage detection. One of the input signals needed by the leakage detection may be set by an estimated signal \hat{d}(n) of the noise signal d[n] at a position where the noise reduction/cancellation occurs.

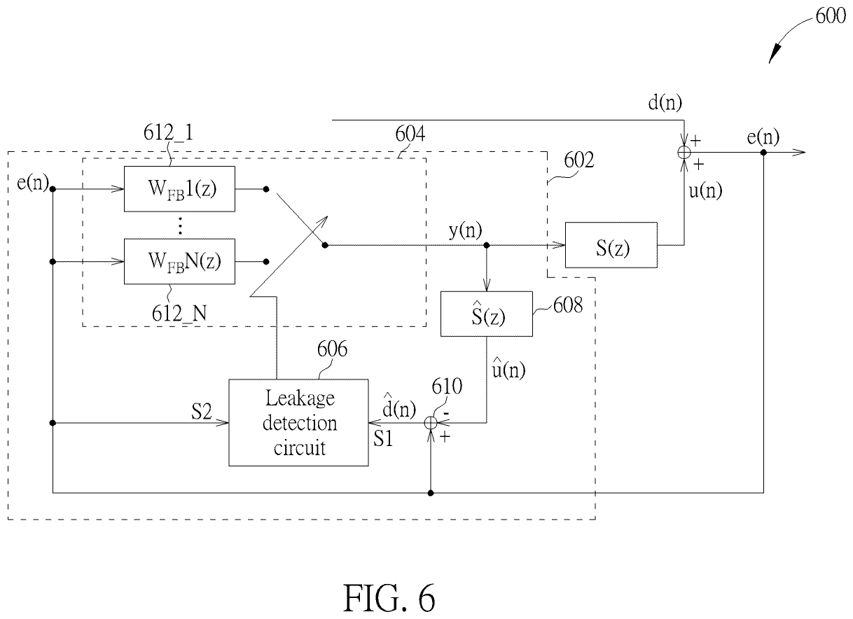

FIG. 6 is a diagram illustrating a fifth adaptive ANC system with leakage detection according to an embodiment of the present invention. The adaptive ANC system 600 includes an ANC circuit 602. The ANC circuit 602 includes an adaptive filter 604, a leakage detection circuit 606, a filter 608, and a combining circuit 610. The audio processing circuit (e.g., ANC circuit) 106 shown in FIG. 1 may be realized by the ANC circuit 602. In this embodiment, the ANC circuit 602 employs an adaptive FB ANC structure having the adaptive filter 604 included therein, where an input of the adaptive filter 604 is derived from the error signal e[n]. As shown in FIG. 6, the adaptive filter 604 is implemented by a selective FB filter having a plurality of static filters 612_1-612_N (N≥2), where the static filter 612_1 has a fixed transfer function W_{EB}1(z) defined by fixed filter coefficients, and the static filter 612_N has a fixed transfer function W_{EB}N(z) defined by fixed filter coefficients. The filter 608 has a transfer function Ŝ(z) which is an estimation of the secondary path transfer function S(z). In this FB ANC structure, the filter 608 and the combining circuit 610 are jointly used for generating an estimated signal \hat{d}[n] from the measured error signal e[n], where the estimated signal d[n] represents an estimation of d[n] (e. g., d[n]=P(z)*x[n], where P(z) is unknown, and x[n] is unavailable due to absence of the reference microphone 102). Specifically, the estimated signal \hat{d}[n] is derived from subtracting an estimated signal û[n] (which is an estimation of signal u[n]) from the error signal e[n].

The leakage detection circuit 606 is arranged to perform leakage detection according to a first input signal S1 and a second input signal S2, and select one of the static filters 612_1-612_N as an active filter of the adaptive filter 604 according to a leakage detection result. In this embodiment, the first input signal S1 is set by the estimated signal \hat{d}[n] (i.e., S1=\hat{d}[n]), and the second input signal S2 is set by the error signal e[n] (i.e., S2=e[n]). Hence, the leakage detection circuit 606 may obtain the leakage detection result through calculating a ratio of the second input signal S2 to the first input signal S1

$$( i . e . , \frac{E [ z ]}{\hat{D} [ z ]} )$$

as a leakage detection factor which is proportional to the leakage condition. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 602 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive ANC filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

Furthermore, the FB ANC system must ensure stability since it is a closed-loop system. The static filters 612_1-612_N of the adaptive filter 604 can be pre-verified to ensure the system stability, eliminating the need to calculate system stability at runtime. Specifically, since the proposed ANC circuit 602 uses pre-defined filters (which are static filters) rather than LMS-based filters (which are adaptive filters), there is no need to ensure the stability of the FB ANC system at runtime, which reduces the computational complexity.

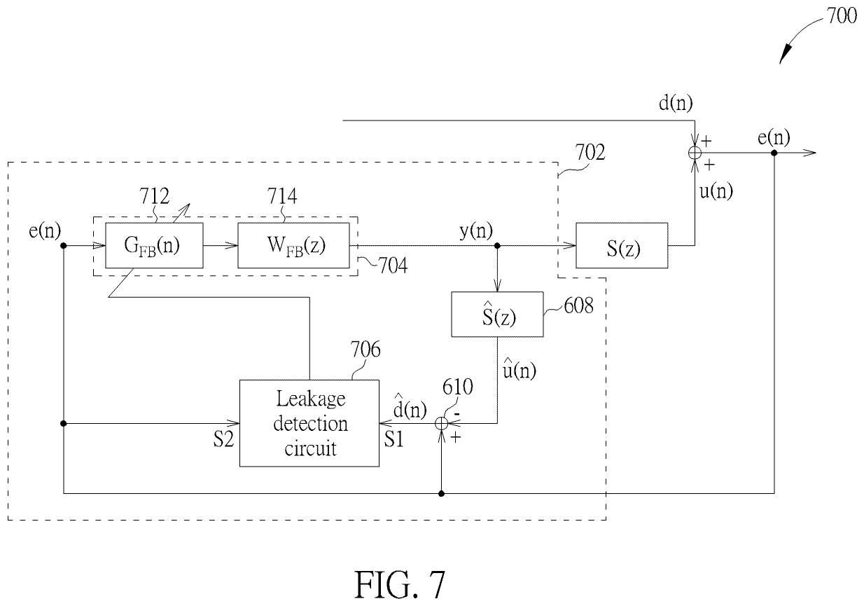

FIG. 7 is a diagram illustrating a sixth adaptive ANC system with leakage detection according to an embodiment of the present invention. The adaptive ANC system 700 includes an ANC circuit 702. The ANC circuit 702 includes an adaptive filter 704, a leakage detection circuit 706, and the aforementioned filter 608 and combining circuit 610. The audio processing circuit (e.g., ANC circuit) 106 shown in FIG. 1 may be realized by the ANC circuit 702. In this embodiment, the ANC circuit 702 employs an adaptive FB ANC structure having the adaptive filter 704 included therein, where an input of the adaptive filter 704 is the error signal e[n]. As shown in FIG. 7, the adaptive filter 704 is implemented by an adaptive gain amplifier 712 and a static filter 714 connected in series, where the static filter 714 has a fixed transfer function W_{FB}(z) defined by fixed filter coefficients, and the adaptive gain amplifier 712 has a controllable gain G_{FB}(n). The leakage detection circuit 706 is arranged to perform leakage detection according to a first input signal S1 and a second input signal S2, and adjust the controllable gain G_{FB}(n) of the adaptive gain amplifier 712 according to a leakage detection result. In this embodiment, the first input signal S1 is set by the estimated signal \hat{d}[n] (i.e., S1=\hat{d}[n]), and the second input signal S2 is set by the error signal e[n] (i.e., S2=e[n]). Hence, the leakage detection circuit 706 may obtain the leakage detection result through calculating a ratio of the second input signal S2 to the first input signal S1

$$( i . e . , \frac{E [ z ]}{\hat{D} [ z ]} )$$

as a leakage detection factor which is proportional to the leakage condition. The ratio is directly proportional to the leakage condition and the filter gain. In other words, when the leakage detection factor becomes larger, the filter coefficients should be larger, resulting in a larger filter gain; and when the leakage detection factor becomes smaller, the filter coefficients should be smaller, resulting in a smaller filter gain.

The leakage detection algorithm has lower computation complexity than any LMS-based algorithm. Hence, the proposed ANC circuit 702 with leakage detection has lower computation complexity since it does not use any LMS-based algorithm. Alternatively, the

$$\frac{E [ z ]}{X [ z ]}$$

ratio used by the proposed leakage detection algorithm may be calculated using an LMS-based algorithm. Compared to a conventional filter controller design that adjusts filter coefficients of an adaptive ANC filter by using an LMS-based algorithm that needs to operate at, for example, 192 KHz and 1024 taps, the proposed leakage detection algorithm only needs an LMS-based algorithm that operates at, for example, 8 KHz and 128 taps to perform filter selection or filter gain adjustment. To put it simply, the

$$\frac{E [ z ]}{X [ z ]}$$

ratio used by the proposed leakage detection algorithm may be obtained with/without the use of an LMS-based algorithm. No matter whether an LMS-based algorithm is used, the leakage detection algorithm has lower computation complexity compared to the conventional filter controller design.

It should be noted that the adaptive gain amplifier 712 is an LTI system, and the adaptive gain amplifier 712 and the static filter 714 may be swapped. In other words, the adaptive gain amplifier 710 may be put before or after the static filter 714, depending upon actual design considerations.

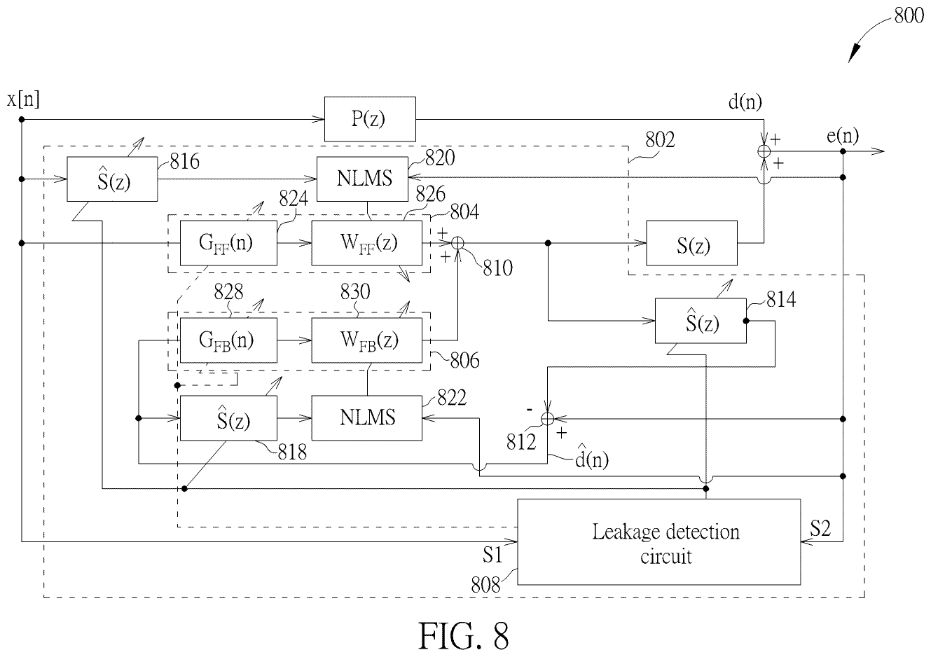

FIG. 8 is a diagram illustrating a seventh adaptive ANC system with leakage detection according to an embodiment of the present invention. The adaptive ANC system 800 includes an ANC circuit 802. The audio processing circuit (e.g., ANC circuit) 106 shown in FIG. 1 may be realized by the ANC circuit 802. In this embodiment, the ANC circuit 802 employs an adaptive hybrid ANC structure which is a combination of an adaptive FF ANC structure and an adaptive FB ANC structure, and has one adaptive filter 804 for the adaptive FF ANC structure and another adaptive filter 806 for the adaptive FB ANC structure. In addition to the adaptive filters 804 and 86, the ANC circuit 802 includes a leakage detection circuit 808, a plurality of combining circuits 810, 812, a plurality of filters 814, 816, 818, and a plurality of LMS-based filter controllers (labeled by “NLMS”) 820, 822. Each of the filters 814, 816, 818 has a transfer function S(z) which is an estimation of the secondary path transfer function S(z). The combining circuit 810 combines outputs of the adaptive filters 804 and 806 to generate the anti-noise signal.

In this embodiment, the adaptive filter 804 may be jointly controlled by the leakage detection circuit 808 and the LMS-based filter controller 820 to improve the ANC performance, and the adaptive filter 806 may be jointly controlled by the leakage detection circuit 808 and the LMS-based filter controller 822 to improve the ANC performance. Specifically, the adaptive filter 804 includes an adaptive gain amplifier 824 and an adaptive filter 826 connected in series, and the adaptive filter 806 includes an adaptive gain amplifier 828 and an adaptive filter 830 connected in series.

The leakage detection circuit 808 is arranged to perform leakage detection according to a first input signal S1 (S1=x[n]) and a second input signal S2 (S2=e[n]), and adjust the controllable gain G_{FF}(n) of the adaptive gain amplifier 824 and the controllable gain G_{FB}(n) of the adaptive gain amplifier 828 according to a leakage detection result.

If the adaptive filter 804 is not considered for simplicity, signals of the adaptive ANC system 800 may be expressed using the following formulas.

$$\hat{D} [ z ] = E ( z ) - \hat{S} ( z ) {G}_{FB} ( z ) {W}_{FB} ( z ) \hat{D} [ z ] \qquad ( 5 )$$

$$\hat{D} [ z ] = \frac{E ( z )}{1 + \hat{S} ( z ) {G}_{FB} ( z ) {W}_{FB} ( z )} \qquad ( 6 )$$

$$E ( z ) = D ( z ) + S ( z ) {G}_{FB} ( z ) {W}_{FB} ( z ) \hat{D} [ z ] = D ( z ) + S ( z ) {G}_{FB} ( z ) {W}_{FB} ( z ) \frac{E ( z )}{1 + \hat{S} ( z ) {G}_{FB} ( z ) {W}_{FB} ( z )} = D ( z ) + \frac{S ( z ) {G}_{FB} ( z ) {W}_{FB} ( z ) E ( z )}{1 + \hat{S} ( z ) {G}_{FB} ( z ) {W}_{FB} ( z )} \qquad ( 7 )$$

$$\frac{E ( z )}{D ( z )} = \frac{1 + \hat{S} ( z ) {G}_{FB} ( z ) {W}_{FB} ( z )}{1 + [ \hat{S} ( z ) ) - S ( z ) ] {G}_{FB} ( z ) {W}_{FB} ( z )} , where ideally , \hat{D} = D \qquad ( 8 )$$

$$\frac{E [ z ]}{\hat{D} [ z ]}$$

ratio will increase when S does not mismatch with Ŝ.

$$\frac{E [ z ]}{\hat{D} [ z ]}$$

could be taken as a leakage detection factor.

The LMS-based filter controller 820 is arranged to adjust a transfer function W_{FF}(z) of the adaptive filter 826 according to an LMS-based algorithm (e.g., a filtered-x normalized least mean square (FxNLMS) algorithm). For example, the Fx-NLMS based adaptive filter 826 has the transfer function W_{FF}(z) defined by filter coefficients that are adaptively adjusted through the Fx-NLMS algorithm. The LMS-based filter controller 822 is arranged to adjust a transfer function W_{FB}(z) of the adaptive filter 830 according to an LMS-based algorithm (e.g., an FxNLMS algorithm). For example, the Fx-NLMS based adaptive filter 830 has the transfer function W_{FB}(z) defined by filter coefficients that are adaptively adjusted through the Fx-NLMS algorithm.

It should be noted that each of the adaptive gain amplifiers 824 and 828 is an LTI system. Hence, the adaptive gain amplifier 824 and the adaptive filter 826 may be swapped, and the adaptive gain amplifier 828 and the adaptive filter 830 may be swapped. In other words, an adaptive gain amplifier (e.g., 824 or 828) may be put before or after an adaptive filter (e.g., 826 or 830), depending upon actual design considerations.

In some embodiments of the present invention, the leakage detection circuit 808 may further refer to the leakage detection result to adjust the transfer function Ŝ(z) of all filters 814, 816, 818 for improving the secondary path estimation accuracy. However, this is for illustrative purposes only, and is not meant to be a limitation of the present invention.

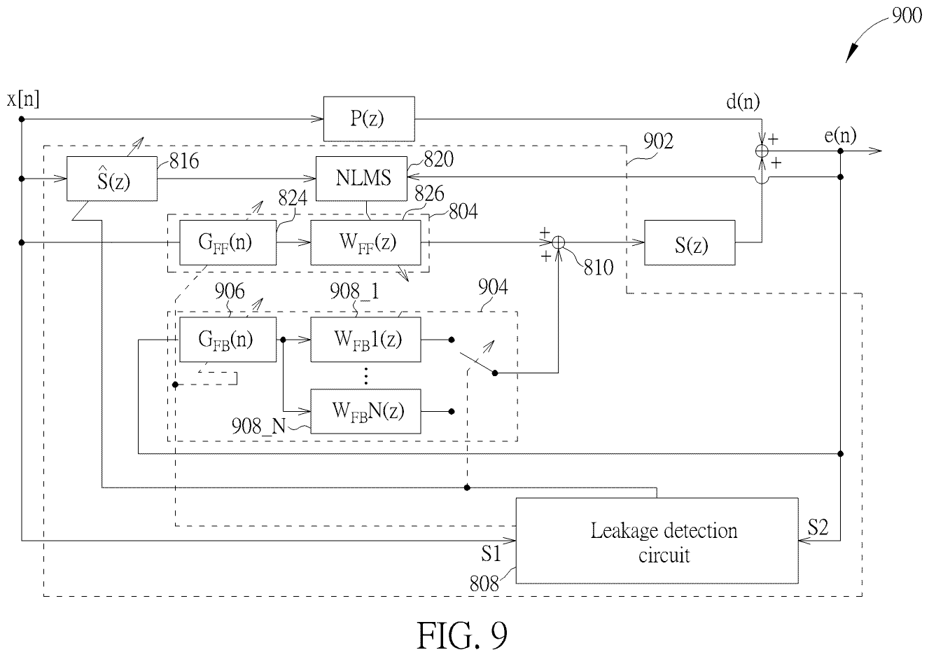

FIG. 9 is a diagram illustrating an eighth adaptive ANC system with leakage detection according to an embodiment of the present invention. The adaptive ANC system 900 includes an ANC circuit 902. The audio processing circuit (e.g., ANC circuit) 106 shown in FIG. 1 may be realized by the ANC circuit 902. In this embodiment, the ANC circuit 902 employs an adaptive hybrid ANC structure which is a combination of an adaptive FF ANC structure and an adaptive FB ANC structure. The major difference between the ANC circuits 802 and 902 is that the adaptive filter 806 is replaced by the adaptive filter 904 which is a selective FB filter, and some components (e.g., filters 814, 818, combining circuit 812, and LMS-based filter controller 822) are omitted. The leakage detection circuit 808 is arranged to perform leakage detection according to a first input signal S1 (S1=x[n]) and a second input signal S2 (S2=e[n]), adjust the controllable gain G_{FF}(n) of the adaptive gain amplifier 824 and the controllable gain G_{FB}(n) of the adaptive gain amplifier 906 according to a leakage detection result, and select one of the static filters 908_1-908_N as an active filter of the adaptive filter 904 according to the leakage detection result. Regarding the adaptive FB ANC structure, the adaptive control of the adaptive filter 904 has lower computation load compared to that the adaptive filter 806.

It should be noted that each of the adaptive gain amplifiers 824 and 906 is an LTI system. Hence, the adaptive gain amplifier 824 and the adaptive filter 826 may be swapped, and the adaptive gain amplifier 906 and a group of adaptive filters 908_1-908_N may be swapped. In other words, the adaptive gain amplifier 824 may be put before or after the adaptive filter 826, depending upon actual design considerations. In addition, the adaptive gain amplifier 906 may be put before or after the group of adaptive filters 908_1-908_N), depending upon actual design considerations.

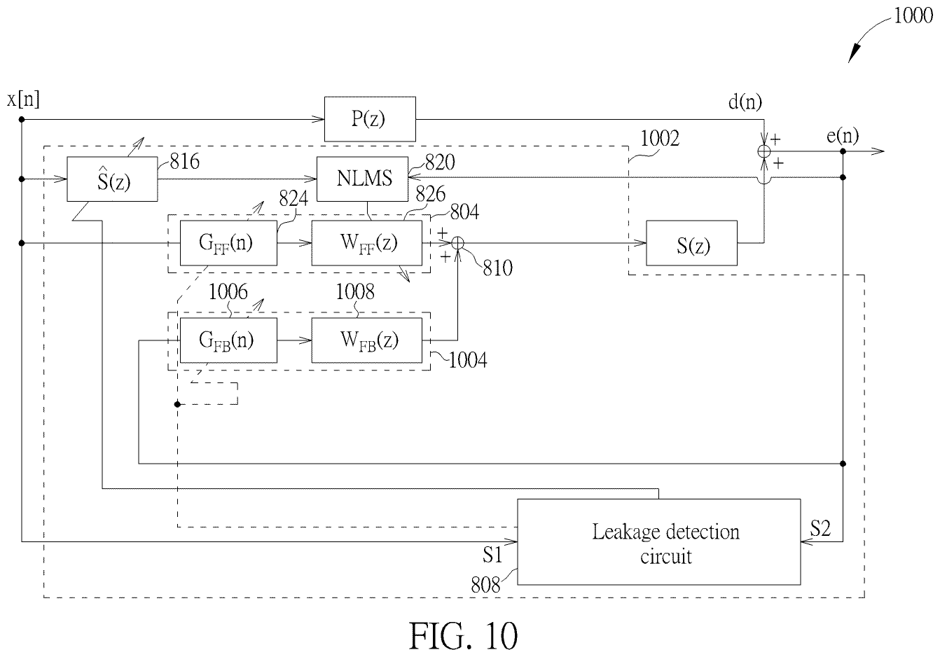

FIG. 10 is a diagram illustrating a ninth adaptive ANC system with leakage detection according to an embodiment of the present invention. The adaptive ANC system 1000 includes an ANC circuit 1002. The audio processing circuit (e.g., ANC circuit) 106 shown in FIG. 1 may be realized by the ANC circuit 1002. In this embodiment, the ANC circuit 1002 employs an adaptive hybrid ANC structure which is a combination of an adaptive FF ANC structure and an adaptive FB ANC structure. The major difference between the ANC circuits 1002 and 902 is that the adaptive filter 904 is replaced by the adaptive filter 1004. The FB filter response curve is usually similar under different leakage conditions. Thus, adjusting the FB filter gain is a simple method to maintain good ANC performance. In this embodiment, the adaptive filter 1004 includes an adaptive gain amplifier 1006 and a static filter 1008 connected in series. The leakage detection circuit 808 is arranged to perform leakage detection according to a first input signal S1 (S1=x[n]) and a second input signal S2 (S2=e[n]), and adjust the controllable gain G_{FF}(n) of the adaptive gain amplifier 824 and the controllable gain G_{FB}(n) of the adaptive gain amplifier 1006 according to a leakage detection result.

It should be noted that each of the adaptive gain amplifiers 824 and 1006 is an LTI system. Hence, the adaptive gain amplifier 824 and the adaptive filter 826 may be swapped, and the adaptive gain amplifier 1006 and the adaptive filter 1008 may be swapped. In other words, an adaptive gain amplifier (e.g., 824 or 1006) may be put before or after an adaptive filter (e.g., 826 or 1008), depending upon actual design considerations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio processing circuit for generating an output signal for an audio function, comprising:
at least one adaptive filter, arranged to control the output signal; and
a leakage detection circuit, arranged to perform leakage detection according to a first input signal and a second input signal, and adjust the at least one adaptive filter according to a leakage detection result, wherein the first input signal is indicative of noise signal signature, and the second input signal is derived from an error signal output by an error microphone that picks up remnant noise resulting from the audio function.

2. The audio processing circuit of claim 1, wherein the first input signal is derived from a reference signal output by a reference microphone that picks up ambient noise.

3. The audio processing circuit of claim 2, wherein the audio processing circuit is an active noise control (ANC) circuit, the output signal is an anti-noise signal, the audio function is noise reduction, and the at least one adaptive filter is a part of an adaptive feedforward ANC structure employed by the ANC circuit.

4. The audio processing circuit of claim 2, wherein the audio processing circuit is an active noise control (ANC) circuit, the output signal is an anti-noise signal, the audio function is noise reduction, and the at least one adaptive filter is a part of an adaptive feedback ANC structure employed by the ANC circuit.

5. The audio processing circuit of claim 2, wherein the audio processing circuit is an active noise control (ANC) circuit, the output signal is an anti-noise signal, the audio function is noise reduction, and the at least one adaptive filter is a part of an adaptive hybrid ANC structure employed by the ANC circuit.

6. The audio processing circuit of claim 1, wherein the first input signal is derived from an estimated signal of a noise signal at a position where the audio function occurs.

7. The audio processing circuit of claim 6, wherein the audio processing circuit is an active noise control (ANC) circuit, the output signal is an anti-noise signal, the audio function is noise reduction, and the at least one adaptive filter is a part of an adaptive feedback ANC structure employed by the ANC circuit.

8. The audio processing circuit of claim 1, wherein the at least one adaptive filter comprises an adaptive filter, the adaptive filter comprises a plurality of static filters, and the leakage detection circuit is arranged to select one of the static filters as an active filter according to the leakage detection result.

9. The audio processing circuit of claim 1, wherein the at least one adaptive filter comprises an adaptive filter, the adaptive filter comprises an adaptive gain amplifier and a filter connected in series, and the leakage detection circuit is arranged to control the adaptive gain amplifier according to the leakage detection result.

10. The audio processing circuit of claim 1, further comprising:
at least one least mean square (LMS) based filter controller, arranged to adjust the at least one adaptive filter according to an LMS-based algorithm.

11. The audio processing circuit of claim 1, wherein the at least one adaptive filter is a pass-through (PT) filter.

12. An audio processing method for generating an output signal for an audio function, comprising:
controlling, by at least one adaptive filter, the output signal;
performing leakage detection according to a first input signal and a second input signal, wherein the first input signal is indicative of noise signal signature, and the second input signal is derived from an error signal output by an error microphone that picks up remnant noise resulting from the audio function; and
adjusting the at least one adaptive filter according to a leakage detection result.

13. The audio processing method of claim 12, wherein the first input signal is derived from a reference signal output by a reference microphone that picks up ambient noise.

14. The audio processing method of claim 13, wherein the audio processing method is an active noise control (ANC) method, the output signal is an anti-noise signal, the audio function is noise reduction, and the at least one adaptive filter is a part of an adaptive feedforward ANC structure employed by the ANC circuit.

15. The audio processing method of claim 13, wherein the audio processing method is an active noise control (ANC) method, the output signal is an anti-noise signal, the audio function is noise reduction, and the at least one adaptive filter is a part of an adaptive feedback ANC structure employed by the ANC circuit.

16. The audio processing method of claim 13, wherein the audio processing method is an active noise control (ANC) method, the output signal is an anti-noise signal, the audio function is noise reduction, and the at least one adaptive filter is a part of an adaptive hybrid ANC structure employed by the ANC circuit.

17. The audio processing method of claim 12, wherein the first input signal is derived from an estimated signal of a noise signal at a position where the audio function occurs.

18. The audio processing method of claim 17, wherein the audio processing method is an active noise control (ANC) method, the output signal is an anti-noise signal, the audio function is noise reduction, and the at least one adaptive filter is a part of an adaptive feedback ANC structure employed by the ANC circuit.

19. The audio processing method of claim 12, wherein the at least one adaptive filter comprises an adaptive filter, the adaptive filter comprises a plurality of static filters, and adjusting the at least one adaptive filter according to the leakage detection result comprises:
selecting one of the static filters as an active filter according to the leakage detection result.

20. The audio processing method of claim 12, wherein the at least one adaptive filter comprises an adaptive filter, the adaptive filter comprises an adaptive gain amplifier and a filter connected in series, and adjusting the at least one adaptive filter according to the leakage detection result comprises:
controlling the adaptive gain amplifier according to the leakage detection result.

21. The audio processing method of claim 12, further comprising:
adjusting the at least one adaptive filter according to a least mean square (LMS) based algorithm.

22. The audio processing method of claim 12, wherein the at least one adaptive filter is a pass-through (PT) filter.
